(19) United States
(12) Patent Application Publication
(10) Pub. No.: US 2015/0294517 A1
(43) Pub. Date: Oct. 15, 2015

(54) WIRELESS LOCKING SYSTEM

(71) Applicant: 9SOLUTIONS OY, Oulu (FI)

(72) Inventor: Sami HERRALA, Oulu (FI)

(73) Assignee: 9SOLUTIONS OY, Oulu (FI)

(21) Appl. No.: 14/683,242

(22) Filed: Apr. 10, 2015

(30) Foreign Application Priority Data
Apr. 11, 2014 (EP) 14164408.8

(51) Int. Cl. G07C 9/00

(52) U.S. Cl. CPC G07C 9/00309; G07C 2009/0038; G07C 2009/00769

(57) ABSTRACT

This document discloses a mobile key for a locking system, the mobile key comprising: a wireless communication circuitry configured to communicate wirelessly with a locking device of the locking system; a memory storing authentication information associated with access rights of the mobile key in the locking system. The mobile key further comprises a radio frequency trigger circuitry sensitized to detect a radio signal received in the mobile key and, upon detecting the reception of the radio signal, to wake up the wireless communication circuitry to communicate with the locking device.

### TECHNICAL FIELD

The present invention relates to wireless locking systems in which a locking device and a key communicate wirelessly with respect to opening the lock.

### TECHNICAL BACKGROUND

A wireless locking system comprises a locking device capable of communicating wirelessly with a key in order to exchange authentication information. If the authentication information associated with the key indicates valid access rights, the locking device may open the lock.

### BRIEF DESCRIPTION

The invention is defined by the independent claims.

Embodiments are defined in the dependent claims.

### BRIEF DESCRIPTION OF THE DRAWINGS

In the following the invention will be described in greater detail by means of preferred embodiments with reference to the attached [accompanying] drawings, in which

FIG. 1 illustrates an example of a scenario to which embodiments of the invention may be applied;

FIG. 2 illustrates a signalling diagram of a procedure according to an embodiment of the invention;

FIG. 3 illustrates a flow diagram of a process according to an embodiment of the invention; and

FIGS. 4 to 6 illustrate block diagrams of apparatuses according to some embodiments of the invention.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

FIG. 1 illustrates a general scenario to which embodiments of the invention may be applied. Referring to FIG. 1, a system according to an embodiment of the invention comprises one or more access-controlled entities, e.g. doors, cabinets, safes, and electronic devices. Access to an access-controlled entity may be controlled by a locking device 102 connected to the access-controlled entity, e.g. a door in FIG. 1. The locking device apparatus 102 may be configured to communicate wirelessly with one or more mobile keys 100 over a radio interface, e.g. over a Bluetooth connection. The Bluetooth connection may employ Bluetooth Low Energy (BTLE) or Bluetooth Smart access scheme. Other radio access schemes are naturally possible, depending on the design of the system. Such other access schemes may comprise IEEE 802.15-based standards such as Zigbee or ANT+. The locking device 102 is configured to communicate with the mobile key 100 in order to verify whether or not the mobile key 100 has access rights to the access-controlled entity connected to the locking device 102. Upon determining that the mobile key 100 has the appropriate rights, the locking device 102 is configured to grant access to the access-controlled entity by opening a mechanical or electromechanical lock and/or by configuring an electronic device to activate and grant operating access, e.g. by logging a user 104 of the mobile key in. When the mobile key 100 does not have the appropriate rights, the locking device 102 is configured to deny the access and maintain the locking status of the access-controlled entity. The communication of the access rights may be carried out by communicating an identifier of the mobile key 100, e.g. a medium access control (MAC) address, to the locking device 102. The locking device 102 may cross-reference the identifier with identifiers comprised in an access database and determine whether or not the mobile key has access to the access-controlled entity. Other authentication mechanisms are also possible.

In many conventional wireless locking systems, the mobile key 100 is a passive tag with no energy source comprised in the mobile key 100. In such embodiments, the key must be brought into a close proximity of the locking device 100, e.g. within a few centimeters, in order to trigger the exchange of the access rights. In such embodiments, the user 104 needs to manually use the mobile key 104. In other wireless locking systems, the mobile key 100 and the locking device may have a limited power source such as a battery. A problem in such systems is the power consumption when the mobile key 100 and the locking device 102 continuously scan a radio channel and attempt to detect a device with which to pair. Such scanning may comprise transmission of beacon or advertisement messages in order to enable the detection. Therefore, it would be advantageous to enable at least one or even both of the locking device 102 and the mobile key 100 to remain in a sleep state or a power-save state until there is a time for exchanging the access rights.

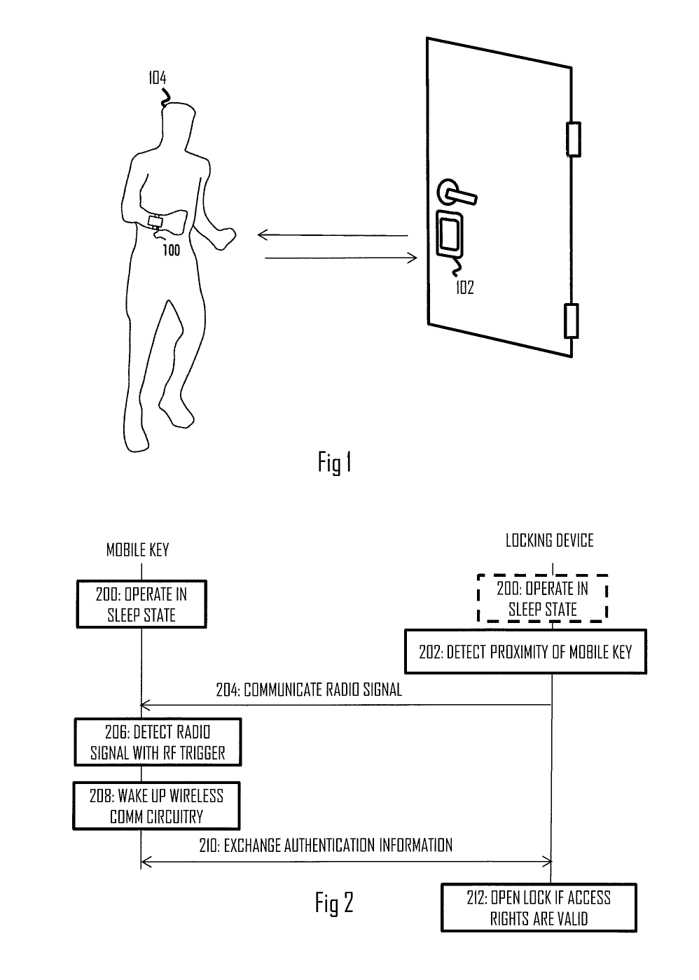

FIG. 2 illustrates a signaling diagram of an embodiment where at least the mobile key 100 may operate in the sleep state until the user 104 approaches the locking device 102. Referring to FIG. 2, at least the mobile key 100 operates in a sleep state in block 200. In some embodiments, the locking device also operates in the sleep state while in other embodiments the locking device may operate in an active state. The sleep state may be defined such that a radio communication circuitry is shut down, e.g. the radio communication circuitry is not able to transmit or receive radio signals. The radio communication circuitry may be a bidirectional radio communication circuitry, e.g. a Bluetooth communication circuitry.

The locking device 102 may be provided with capability of detecting close proximity between the mobile key 100 and the locking device 102. Below, some embodiments for providing this capability are disclosed. In block 202, the locking device detects the proximity of the mobile key and configures its radio communication circuitry to transmit a radio signal to the mobile key 100. The mobile key may comprise a radio frequency (RF) trigger circuitry sensitized to radio signals transmitted by the locking device. The RF trigger circuitry may be defined as a low-power circuitry dedicated to detect RF energy and output a control signal in response to the detected RF energy (block 206). The control signal may activate or wake up the wireless communication circuitry of the mobile key (block 208). When the wireless communication circuitry of the mobile key 100 has been activated, the mobile key 100 may communicate with the wireless communication circuitry of the locking device 102 and exchange authentication information in step 210. The authentication information may carry information on the access rights of the mobile key 100 to the access-controlled entity controlled by the locking device 102. If the authentication information indicates valid access rights, the locking device may open the lock in block 212. Block 212 may comprise actually opening the lock or connecting an opening mechanism of the lock to a handle, for example, such that the user operating the handle may open the lock manually.

Providing the mobile key with the RF trigger circuitry enables the shutdown of the wireless communication circuitry used for the actual communications. The RF trigger circuitry may be sensitive to any radio signal waveform to which it has been sensitized regardless of the information carried by the radio signal waveform. Accordingly, the RF trigger may be sensitized to radio signal energy transmitted on a determined frequency band comprising the operating frequency band of the wireless.

In an embodiment, the RF trigger circuitry is designed to have lower power consumption properties than the wireless communication circuitry. This may be realized by providing the RF trigger circuitry with less computational capacity and/or less functions. For example, the RF trigger circuitry may be stripped of transmission functions while the wireless communication circuitry may be configured to have transmission and reception functions. Additionally, the RF trigger circuitry may be configured to process the received radio signal with less receiver functions than the wireless communication circuitry, thus reducing the required processing capacity. In an embodiment, the wireless communication circuitry may be realized by an embedded system consuming current in a reception mode in the order of milliamperes while the RF trigger circuitry may consume current in the order of microamperes, thus reducing the power consumption significantly in the reception mode. This also provides for that the RF trigger circuitry may be kept activated continuously without causing excessive power consumption and yet providing for fast wake-up upon detecting the wake-up signal from the locking device. Accordingly, the fast response to the wake-up signal may be provided together with the low power consumption.

In an embodiment, the wireless communication circuitry of the mobile key 100 is realized by a Bluetooth chip such as Texas Instruments CC2540 while the RF trigger circuitry is realized by a microcontroller such as Microchip PIC16F1508. The wireless communication circuitry and the RF trigger circuitry may employ at least partially the same RF components of the mobile key, e.g. an antenna and RF front-end components.

The feature of configuring the mobile key to have low power consumption and yet constantly monitoring for the wake-up radio signals from a locking device enables seamless unlocking capability. The connection between the wireless communication circuitries of the locking device 102 and the mobile key 100 may be established immediately after the execution of step 204 for the first time, e.g. the continuous activity of the RF trigger reduces the probability of missing a signal transmitted by the locking device 102. In an embodiment, an average duration from the start of step 204 to the completion of step 212 is in an order of milliseconds or tens of milliseconds, which may be considered as immediate for a human being.

The system according to the embodiments may be usable, for example, in a scenario where a person enters a room or a corridor comprising several doors, each with a separate locking device, and the person has access rights only to one of the locking devices. The locking devices may employ a common proximity detector detecting the presence of a mobile key carried by the person or the person himself/herself. As a consequence, the locking devices may all start transmitting the radio signal waking up the wireless communication circuitry of the mobile key 100 to carry out authentication. As the mobile key 100 has access rights only to one of the locking devices, only that one of the locking devices will grant access while the other locking devices remain locked. Accordingly, the user may access the appropriate locking device.

In an embodiment, the RF trigger is also put into the sleep state in a determined context. For example, the RF trigger may be put into the sleep state when the mobile key 100 is detected to be stationary, i.e. not moving. In such contexts, it is probable that the mobile key 100 is not approaching any locking device 102, and the RF trigger circuitry may also be put into the sleep state. When the mobile key 100 moves, the RF trigger circuitry may be activated to receive RF signals. In this respect, the mobile key 100 may comprise a motion sensor configured to monitor motion of the mobile key and output a control signal to the RF trigger on the basis of the detected motion of the mobile key. The motion sensor may be based on accelerometer technology, gyroscope technology, and/or magnetometer technology, for example. The motion sensor may further comprise a processor configured to analyze measured motion data and output a corresponding control signal to the RF trigger. For example, when the measured motion data indicates that the mobile key 100 has not moved for a determined period of time, the processor may output a control signal commanding the RF trigger to enter the sleep state. When the measured motion data indicates that the mobile key 100 is moving, the processor may output a control signal activating the RF trigger. The use of the sleep state of the RF trigger circuitry further reduces the power consumption in the mobile key 100.

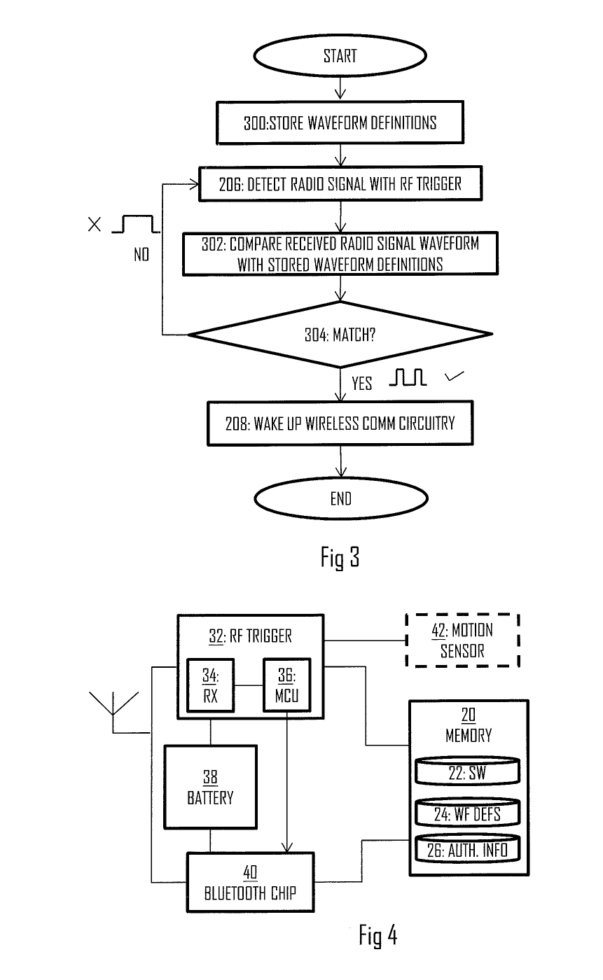

In some scenarios, the RF trigger sensitized to all radio signals on an unlicensed frequency band is subject to outputting the wake-up signals constantly. Accordingly, the wireless communication circuitry is activated unnecessarily and the power consumption of the mobile key 100 increases. In an embodiment, the locking device is configured to transmit a predetermined signal waveform in step 204 and the RF trigger circuitry is sensitized particularly to the predetermined waveform. In other words, only the predetermined waveform triggers the execution of block 208 and the activation of the wireless communication circuitry, while other signal waveforms do not cause the execution of block 208. FIG. 3 illustrates an embodiment of such a process that may be carried out in a signal processor of the RF trigger circuitry. Referring to FIG. 3, definitions of one or more of the predetermined waveforms to which the RF trigger circuitry is sensitized is/are stored in a memory of the mobile key. Block 300 may be carried out beforehand during manufacturing or initialization of the mobile key 100. During the operation, the RF trigger circuitry may be active while the wireless communication circuitry is in the sleep state. In block 302, the reception of the radio signal is detected in the RF trigger circuitry. Block 302 may comprise receiving the radio signal through the RF components of the mobile key. The reception of the radio signal may cause execution of block 302 in which the signal processor of the RF trigger circuitry compares the received signal waveform with the waveform definitions stored in block 300. In an embodiment, block 302 is carried out on baseband. In an embodiment, the signal processor may employ a correlator receiver or a matched filter receiver structure, wherein the correlator or the matched filter is adapted to realize the waveform definitions stored in the memory. The received signal waveform may be input to the correlator or the matched filter, and an output of the correlator or the matched filter may be connected to a peak detector or a threshold detector determining whether or not a peak or a sufficiently high signal level is detected at the output of the correlator or the matched filter. The high signal level indicates high correlation between the received signal waveform and a reference signal waveform modelled by the correlator or the matched filter. If the high correlation between the received signal waveform and the reference signal waveform is detected (block 304), the process may proceed to block 208 and the wireless communication circuitry may be activated. Otherwise, the process may end or return to block 206 to process another received signal waveform. It should be appreciated that another signal correlation algorithm may be used in block 302.

The waveform to which the RF trigger is sensitized may be a generic radio signal waveform to which at least one other RF trigger is also sensitized. Accordingly, the waveform need not carry a unique identifier of the RF trigger, for example. For example, all the mobile keys employed in the system and configured to access the locking device may be sensitized to the same waveform. As a consequence, the locking device transmitting the waveform does not need to send a separate waveform to each mobile key or different subsets of mobile keys but a single waveform triggers all mobile keys configured to access the locking device. In an embodiment, different locking devices of the system may employ a different waveform and the access rights of the mobile keys may be managed by sensitizing them to waveforms of only those locking devices to which they have access rights. Accordingly, the RF trigger of a mobile key having no access rights to a given locking device may not respond to a radio signal waveform transmitted by the locking device and, accordingly, the RF trigger will not activate the wireless communication circuitry. Accordingly, the RF trigger will not unnecessarily wake up the wireless communication circuitry and power consumption may be further reduced. Such a scheme also avoids scenarios where the RF transmissions operate on Gigahertz bands where RF signals may penetrate structures such as walls or floors/ceilings. This type of sensitization may reduce the situations where a locking device on one floor of a building triggers a mobile key on another floor of the building, for example. Manual fine-tuning of transmission powers of the locking devices may even be avoided. In addition to the sensitization of the RF triggers as a tool for performing the authentication, a conventional authentication through the wireless communication circuitry may be employed for the locking devices that transmit a waveform to which the RF trigger is sensitized.

In an embodiment, the RF trigger is sensitized to Bluetooth signals and desensitized to other radio signal waveforms typically present on the same band, e.g. Wi-Fi signals according to IEEE 802.11 specifications. The RF trigger may comprise a comparator circuit configured to output a square wave signal in response to a radio signal it receives, and the presence of the Bluetooth signal or, in general, the desired radio signal waveform may be determined from the properties of the square wave signal. FIG. 3 illustrates such an embodiment where the signal resulting in the match in block 304 has a shorter duty cycle of the square wave signal than the signal not providing the match. It has been discovered that the RF trigger outputs a square wave signal having a longer duty cycle when the input RF signal is a Wi-Fi signal than when the input RF signal is a Bluetooth signal. Accordingly, block 304 may comprise analyzing the duty cycle of a signal output by the RF trigger circuitry. If the duty cycle is determined to match with a duty cycle that is searched for, the process may proceed to block 208 and, otherwise, the process may return to block 206.

Let us now consider the structure of the mobile key according to an embodiment of invention with reference to FIG. 4. The mobile key may comprise the wireless communication circuitry 34, e.g. a Bluetooth chip, configured to communicate wirelessly with the locking device of the locking system. The mobile key may further comprise a memory 20 storing authentication information 26 associated with access rights of the mobile key in the locking system. The mobile key may further comprise the RF trigger circuitry 32 sensitized to detect a radio signal received in the mobile key and, upon detecting the reception of the radio signal, to wake up the wireless communication circuitry 40 to communicate with the locking device. In an embodiment, the RF trigger circuitry 32 may comprise a receiver 34 configured to preprocess a received signal and at least one processor 36, e.g. a micro controller, configured to perform digital signal processing for the received radio signal. Depending on the embodiment, the RF trigger may comprise only the processor 36 while the receiver 34 may be provided outside the RF trigger circuitry, e.g. when the RF trigger circuitry and the wireless communication circuitry employ the same components. Such components may include the antenna, RF filtering and amplification, frequency conversion between RF band and base band, analog-to-digital conversion, etc. The RF trigger circuitry 32 and the wireless communication circuitry 40 may acquire power supply from a battery 38 comprised in the same casing in the mobile key. In some embodiments where the processor 36 is configured to carry out the process of FIG. 3, the memory 20 may store a database 24 comprising the waveform definitions. In such embodiments, the processor may comprise or realize functions of a waveform analyser circuitry. Furthermore, the memory 20 may store one or more computer programs 22 comprising a computer program code defining the functions of the processor 36 and the wireless communication circuitry 40.

The mobile key may, in some embodiments, further comprise the motion sensor 42 configured to control the sleep state of the RF trigger circuitry 32 in the above-described manner.

In an embodiment, the RF trigger circuitry and the wireless communication circuitry 40 are active alternately. In an embodiment, the state of the RF trigger circuitry 32 is dependent on the state of the wireless communication circuitry 40. For example, whenever the wireless communication circuitry 40 is powered on, the RF trigger circuitry may be in the sleep state. Whenever the wireless communication circuitry 40 is in the sleep state, the RF trigger circuitry may be active. In an embodiment, the RF trigger circuitry 32 and the wireless communication circuitry are not active at the same time and/or sleeping at the same time, except for during transitions between the sleep state and the active state in some embodiments. In order to control the activation and deactivation of the circuitries 32, 40, the mobile key may comprise a state controller circuitry (not shown in FIG. 3) connected to the RF trigger circuitry 32 and the wireless communication circuitry 40 and configured to control the operational states of the circuitries 32, 40.

As described above, the activation of the mobile key and the authentication may be carried out in the order of milliseconds. Because of the fast unlocking feature, it is possible to design the locking system accurately so that the unlocking is controlled by the selection of the proximity detection feature (block 202). In some embodiments, the proximity detection is realized such that block 202 is executed when the user 104 is detected from a distance, e.g. a meter or a few meters from the access-controlled entity. In other embodiments, the proximity detection is realized such that block 202 is executed when the user 104 is detected within a reaching distance from the access-controlled entity. In yet other embodiments, the proximity detection is realized such that block 202 is executed when the user 104 is detected to be touching the access-controlled entity. It should be appreciated that all embodiments may be realized such that the user 104 needs not to manually operate the mobile key 100 in order to open the lock or command wireless communication between the wireless communication circuitries of the mobile key and the locking device.

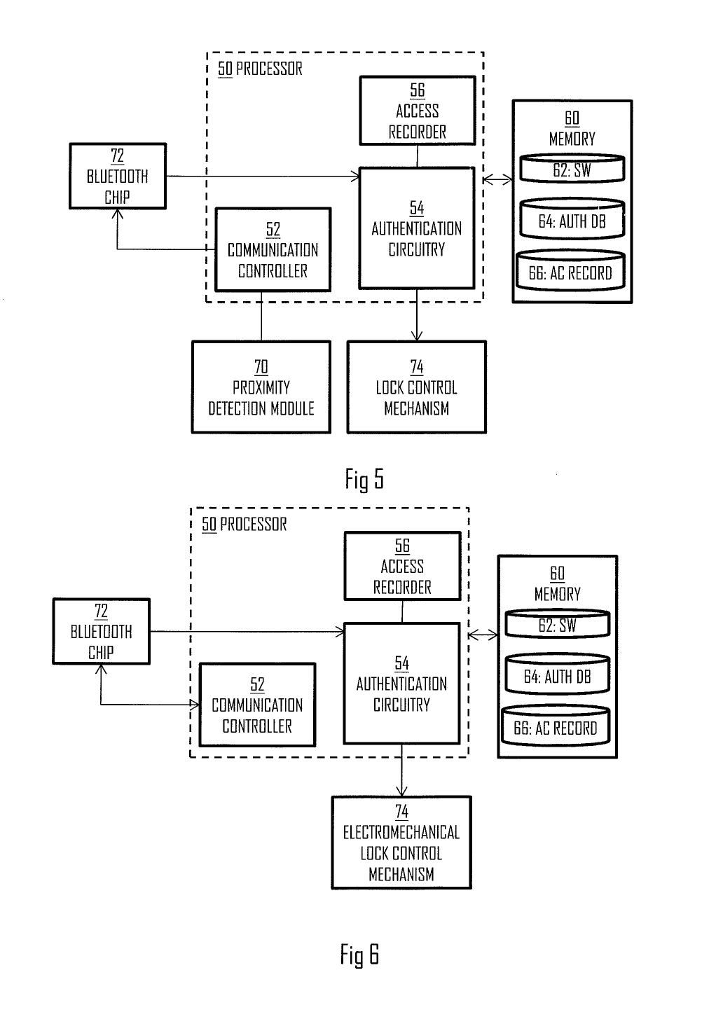

Let us now consider some embodiments of the structure of the locking device 102 with reference to FIGS. 5 and 6. The locking device may comprise the wireless communication circuitry 72, e.g. a Bluetooth chip. The locking device may further comprise at least one processor 50 and at least one memory storing a computer program code 62 defining functions of the at least one processor 50. The locking device may further comprise a lock control mechanism 74 configured to control a locking status of an access-controlled entity to which the locking device is attached. The lock control mechanism 74 may control an electromechanical lock or an electronic lock of an electronic device, e.g. a computer. The processor 50 may comprise, as a sub-circuitry, an authentication circuitry 54 configured to carry out the above-described authentication of the mobile key from which the wireless communication circuitry 72 has received the authentication information. Upon determining that the mobile key has valid access rights, the authentication circuitry 54 may control the lock control mechanism 74 to open access to the access-controlled entity. The authentication circuitry 54 may also output an identifier of the mobile key to an access recorder 56. The access recorder 56 may store and maintain an access control record 66 in the memory 60. The access recorder 56 may store in the access control record identifiers of the mobile keys processed by the authentication circuitry and, in some embodiments, a time of attempted access by the mobile keys. Accordingly, the access control record 66 may store information on mobile keys that have tried to access the access-controlled entity and information on the granted or refused access. The locking device may periodically synchronize the access control record 66 with a server computer connected to a plurality of locking devices of the locking system. Accordingly, the server may store the access records in a centralized manner.

The processor 50 may further comprise a communication controller 52 configured to control the wireless communication circuitry 72. In an embodiment, the communication controller 52 may control the operational state of the wireless communication circuitry 72, e.g. a sleep state and an operational state. In an embodiment, the communication controller 52 may maintain the wireless communication circuitry in the sleep state when proximity of no mobile keys with respect to the locking device is detected (block 200). Accordingly, the power consumption in the locking device may be reduced. When a mobile key is detected in the proximity of the locking device, the communication controller 52 may wake up the wireless communication circuitry 72 and cause the wireless communication circuitry 72 to transmit the radio signal (step 204). The proximity detection of the mobile key may be carried out by a sensor comprised in the locking device or by an external proximity detection system. FIG. 5 illustrates an embodiment where the locking device comprises a proximity detection module 70 comprising at least one sensor configured to sense the proximity of the mobile keys. Upon detecting the proximity of a mobile key, the proximity detection module 70 may output a signal to the communication controller 52, and the communication controller 52 may cause the wireless communication circuitry 72 to transmit the radio signal to the mobile key. The radio signal may be a broadcast signal or an advertisement signal enabling the mobile key to activate its wireless communication circuitry 40 and initiate pairing between the mobile key and the locking device.

In an embodiment, the sensor of the proximity detection module 70 is configured to detect the mobile keys while in other embodiments the proximity detection module 70 is configured to detect the user 104.

In an embodiment, the proximity detection module 70 comprises an image sensor configured to capture image data and to process the image data. The processing may comprise image analysis such as motion or pattern recognition in order to detect a human body. The image data may be infrared or thermal image data or other image data. In an embodiment, the image data may be produced by reception of reflections of a scanning signal such as a radio scanning signal, and the image data may be constructed form the reflections. Upon detecting a determined pattern or motion in the image data, the proximity detection module 70 may output the signal to the communication controller 52. The detection of the mobile key may be based on detecting transmissions of the mobile key, e.g. the wireless communication circuitry 40 of the mobile key may be used to transmit signals periodically or intermittently. In an embodiment where the locking device is attached to a door, the proximity detection module 70 may be configured to sense on both sides of the door, e.g. by employing signals that penetrate the door.

In an embodiment, the proximity detection module comprises a motion sensor connected to the locking device. The motion sensor may be sensitized to a motion waveform caused by the user 104 knocking the door. Upon detecting the motion waveform, the proximity detection module 70 may output the signal to the communication controller 52.

In an embodiment, the proximity detection module comprises a capacitive sensor configured to sense capacitive coupling from a surface of the access-controlled entity. The capacitive sensor may be connected to a door handle, for example. When the user 104 touches the capacitive sensor, the proximity detection module may output the control signal to the communication controller 52 and cause the communication controller to send the radio signal waking up the mobile key.

In the embodiment of FIG. 6, the proximity detection module is omitted from the locking device, and the proximity detection is carried out by an external system. Such a system may be a location tracking system (LTS) which may be an indoor or outdoor location tracking system. For example, a plurality of LTS nodes may be disposed throughout an area in which the location tracking is carried out. The LTS nodes may be radio communication devices, each configured to provide a coverage area, and the combined coverage areas of the LTS nodes cover the location tracking area. The LTS nodes may also form a mesh network enabling data routing between the nodes 104 and through the nodes. A location tracking apparatus that may be comprised in a server may be connected to the network of LTS nodes, and the location tracking apparatus may be configured to maintain locations of tracked objects and control the location tracking and other features of the LTS. The server and the location tracking apparatus may be realized by a computer provided with suitable communication equipment so as to enable a communication connection with the LTS nodes. The server may be connected to a router via an Internet Protocol (IP) connection, and the router may be configured to connect to the mesh network of LTS nodes through another connection type. The connection in the mesh network of LTS nodes may be configured to establish the mesh network according to a Bluetooth technology, but it should be understood that other radio communication schemes may be used as well.

The locations of objects are tracked by tracking movement of the mobile tags attached to the objects. For example, a user tag may be carried by a person, and an asset tag may be attached to an asset. The asset may be any mobile or portable apparatus that is wanted to be tracked, e.g. a wheelchair, a computer, or expensive industrial testing equipment. The asset tag may equally be attached to a fixed apparatus, e.g. a safe, a projector, in order to detect attempted robbery. The different tags whose movement and location are tracked may be called generally mobile tags. The location tracking may be based on a scheme where a mobile tag is configured to detect the closest LTS node and to transmit to the server periodically a message comprising an identifier of the mobile tag and an identifier of the detected closest LTS node. The message may be routed through the mesh network of LTS nodes to the server. As the server is provided with information on fixed locations of the LTS nodes, e.g. in a layout of the area, the server is able to associate the mobile tag with the LTS node on the basis of the received message and, thus, determine the location of the mobile tag and the object associated with the mobile tag. In another embodiment, an LTS node is configured to detect mobile tags in its coverage area and transmit periodically identifiers of detected mobile tags to the server. The detection of the LTS nodes or mobile tags may be based on Bluetooth inquiry procedure. The LTS may, however, utilize another location tracking scheme and/or another communication scheme.

In an embodiment, the mobile key comprises the features of the mobile tag. In such an embodiment, the wireless communication circuitry 40 may be configured to wake up periodically and carry out the positioning by exchanging signals with the LTS nodes. However, the period may be one minute or even some minutes, depending on the embodiment. Accordingly, the wireless communication circuitry may be powered for a time interval of a few milliseconds or dozens of milliseconds with the determined periodicity and in the sleep state for the most of the time. Such periodicity is typically adequate for location tracking purposes but too long for the unlocking functionality. Let us assume that the user 14 approaches the door. The proximity used in the detection that the user 14 is about to attempt accessing the locking device is typically in the order of a few meters, a meter, or even less than a meter and the unlocking should occur within the duration the user 14 spends to proceed from the edge of the detection area to the actual opening of the access-controlled entity. This is typically in the order of a few seconds, a second, or even less than a second in embodiments where the proximity is based on detection of the user 14 touching the access-controlled entity. Increasing the wake-up periodicity of the wireless communication circuitry 40 so much typically results in unacceptable power consumption in the mobile key. Furthermore, such periodicity is typically unnecessarily high for the location tracking and most of the wake-ups are for naught because the user 14 typically accesses the access-controlled entities only occasionally. Using the RF trigger circuitry in such an embodiment enables the mobile key to use the wireless communication circuitry 40 with the periodicity that is suitable for the positioning and, additionally, wake up the wireless communication circuitry 40 for the unlocking events when necessary. Accordingly, the unlocking may be carried out with the fast response and the power consumption of the mobile key may be reduced.

In an embodiment, the locking device comprises the features of the LTS node while, in other embodiments, the LTS nodes are separated from the locking devices. FIG. 6 illustrates the latter embodiment. Referring to FIG. 6, upon detecting a mobile tag within proximity of the locking device, e.g. as being associated with an LTS node covering an area in which the locking device is disposed, the location tracking apparatus may output a control signal to the locking device through the wireless communication circuitry 72 and, in some embodiments, through the network of LTS nodes. Upon receiving the control signal from the location tracking apparatus, the wireless communication circuitry 72 may output the control signal to the communication controller 52, and the communication controller 52 may control the wireless communication circuitry to execute step 204 and to wake up the mobile key for the authentication. In another embodiment, the location tracking apparatus may transmit the control signal directly to the mobile key through the LTS node network, thus waking up the mobile key when the mobile key detects a radio signal carrying the control signal. The LTS nodes may use a dedicated signal waveform to transfer the control signal, and the RF trigger circuitry of the mobile key may be sensitized particularly to that signal waveform.

All of the above-described embodiments may be designed such that the unlocking may be carried out without manual user intervention or even the user not detecting the unlocking. This is particularly convenient in applications where the mobile key is carried by a child, a patient, or an elderly. From the user's 104 point of view, the locked door functions as an unlocked door because the unlocking is carried out in a fully automated manner and so rapidly that the user does not observe the unlocking. Additionally, power consumption of the mobile key may be reduced by using the RF trigger circuitry.

In an embodiment, the mobile key comprises functions of an alarming system as well. For example, the mobile key may comprise an alarm button which, upon being pressed by the user, causes the mobile key to activate the wireless communication circuitry to transmit an alarm signal to the server, e.g. through the LTS node network.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in connection with FIGS. 2 and 3 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to locking systems described above. Any development of such systems may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A mobile key for a locking system, the mobile key comprising:
a wireless communication circuitry configured to communicate wirelessly with a locking device of the locking system;
a memory storing authentication information associated with access rights of the mobile key in the locking system;
a radio frequency trigger circuitry sensitized to detect a radio signal received in the mobile key and, upon detecting the reception of the radio signal, to wake up the wireless communication circuitry to communicate with the locking device.

2. The mobile key of claim 1, wherein the wireless communication circuitry is configured to remain in a sleep state until receiving a wake up signal from the radio frequency trigger circuitry.

3. The mobile key of claim 1, wherein the radio frequency trigger circuitry is sensitized to a predetermined waveform transmitted by the locking device.

4. The mobile key of claim 3, wherein the memory stores definitions of the predetermined waveform, and wherein the radio frequency trigger circuitry comprises a waveform analyser circuitry configured to compare a received radio signal with the stored definitions of the predetermined waveform and, upon determining on the basis of the comparison that the received radio signal has the predetermined waveform, wake up the wireless communication circuitry.

5. The mobile key of claim 3, wherein the mobile key is sensitized to radio signals transmitted according to a first radio communication technology and not sensitized to radio signals transmitted according to a second radio communication technology operating on the same frequency band as the first radio communication technology.

6. The mobile key of claim 1, wherein the radio frequency trigger circuitry is designed to have lower power consumption properties than the wireless communication circuitry.

7. The mobile key of claim 1, further comprising a motion sensor configured to measure motion of the mobile key and control a sleep state of the radio frequency trigger circuitry according to the measured motion.

8. A locking system comprising:
a mobile key comprising a wireless communication circuitry configured to communicate wirelessly with a locking device of the locking system, a memory storing authentication information associated with access rights of the mobile key in the locking system, and a radio frequency trigger circuitry sensitized to detect a radio signal received in the mobile key and, upon detecting the reception of the radio signal, to wake up the wireless communication circuitry to communicate with the locking device;
said locking device comprising a lock, a wireless communication circuitry, and a controller configured to receive, through the wireless communication circuitry, authentication information associated with access rights of the mobile key and to open the lock, if the authentication information indicates valid access rights to the lock.

9. The locking system of claim 8, further comprising a proximity detection system configured to detect proximity between the mobile key and the locking device and, upon detecting the proximity, configure the wireless communication circuitry of the locking device to transmit the radio signal for which the radio frequency trigger of the mobile key is sensitized.

10. The locking system of claim 9, wherein the proximity detection system comprises an indoor positioning system configured to track movement of the mobile key in an indoor area.

11. The locking system of claim 9, wherein the proximity detection system comprises a motion sensor connected to the locking device.

12. The locking system of claim 9, wherein the proximity detection system comprises a capacitive sensor connected to the locking device, wherein the capacitive sensor is configured to sense capacitive coupling from a surface of an object to which the lock is fixed.

13. The locking system of claim 8, wherein the radio frequency trigger circuitry of the mobile key is sensitized to a predetermined waveform transmitted by the locking device.

14. The locking system of claim 13, wherein the memory of the mobile key stores definitions of the predetermined waveform, and wherein the radio frequency trigger circuitry of the mobile key comprises a waveform analyser circuitry configured to compare a received radio signal with the stored definitions of the predetermined waveform and, upon determining on the basis of the comparison that the received radio signal has the predetermined waveform, wake up the wireless communication circuitry.

15. The locking system of claim 13, further comprising at least a second mobile key comprising a wireless communication circuitry configured to communicate wirelessly with said locking device or another locking device of the locking system, a memory storing authentication information associated with access rights of the mobile key in the locking system, and a radio frequency trigger circuitry sensitized to detect a radio signal received in the mobile key and, upon detecting the reception of the radio signal, to wake up the wireless communication circuitry to communicate with the locking device, wherein the radio frequency trigger circuitry of the second mobile key is sensitized to the same predetermined waveform as said mobile key.

16. The locking system of claim 13, further comprising at least a second mobile key comprising a wireless communication circuitry configured to communicate wirelessly with said locking device or another locking device of the locking system, a memory storing authentication information associated with access rights of the mobile key in the locking system, and a radio frequency trigger circuitry sensitized to detect a radio signal received in the mobile key and, upon detecting the reception of the radio signal, to wake up the wireless communication circuitry to communicate with the locking device, wherein the radio frequency trigger circuitry of the second mobile key is sensitized to a predetermined waveform different from said predetermined waveform to which the radio frequency trigger circuitry of said mobile key is sensitized.

17. The locking system of claim 13, wherein the radio frequency trigger circuitry is sensitized only to a waveform or waveforms transmitted by a locking device to which the mobile key has access rights.
